(19) United States
(12) Patent Application Publication
(10) Pub. No.: US 2016/0029680 A1
(43) Pub. Date: Feb. 4, 2016

(54) FOOD PRODUCT

(71) Applicant: Christopher Brian LUNDIN, Newark, DE (US)

(72) Inventor: Christopher Brian LUNDIN, Newark, DE (US)

(21) Appl. No.: 14/816,343

(22) Filed: Aug. 3, 2015

(30) Foreign Application Priority Data
Aug. 4, 2014 (ZA) 2014/04619

(51) Int. Cl. A23L 1/29

(52) U.S. Cl. CPC A23L 1/293; A23L 1/296; A23V 2002/00

(57) ABSTRACT

A bulk food product, for use in a weight management program, which includes a number of portions each of which comprises a complete meal which includes fiber and essential nutrients from protein, carbohydrate and fat, in proportions to stabilize insulin levels.

### BACKGROUND OF THE INVENTION

This invention relates to the management of an individual's weight in a nutritionally sound manner.

### Unhealthy Habits

Busy lifestyles can make it difficult for many consumers to prepare fresh wholefood for themselves and their families.

Food marketers have responded to the opportunity with the development and supply of highly processed convenient foods such as ready to eat fast food, frozen dinners and meals, protein and meal replacement bars, shakes, snacks, chips, cookies, candy bars and energy drinks.

To cut costs, improve yields and extend the shelf life of processed foods, animals are fed antibiotics and growth hormones; crops are genetically modified; high fructose corn syrup, additives, preservatives and dyes are added to food products; and protein replacement foods, such as soy, whey and manipulated animal proteins, are used.

These highly processed foods are marketed as healthy and convenient substitutes for wholefoods. Many consumers, instead of buying fresh wholefoods, cooking balanced meals and preparing wholefood snacks, have gravitated to convenience foods.

Convenience foods can have a negative effect on diet-induced thermogenesis and cause insulin spikes resulting in an increase in obesity and obesity-related conditions, such as insulin resistance, and diseases including heart disease, type-2 diabetes and some physical and neurological disorders.

Insulin resistance has the effect of working against weight loss, and facilitating weight gain.

### Pseudo Healthy Foods

As obesity levels increase, more aggressive measures are adopted in order to lose weight. Food and drink manufacturers have taken advantage of this situation by developing and marketing low fat and low calorie versions of convenience foods or low fat replacement meals, shakes or beverages and marketing them as “healthier” than the high calorie counterparts. These products frequently contain components of low nutritional value, such as artificial sugars, to reduce their calorie content. Often, additives, flavorings and preservatives are added to extend shelf life and improve taste.

The replacement meals normally contain high levels of sugars and are not complete, balanced meals. The high sugar levels can cause insulin spikes which promote the development of insulin resistance. This type of meal generally ranges between 150 and 250 calories with an average of around 200 calories. These meals on their own, based on three meals a day, do not meet recognised safe minimum caloric requirements (e.g. 1200 calories). Some diet companies recommend an intake of less than 800 calories per day—an unsafe level which is likely to promote muscle loss and dehydration, resulting in false weight loss, and hunger pangs or cravings which can cause binge eating. Considering their low calorie content, these meals are expensive and offer little value for money.

### Healthy Lifestyles

Despite the market being flooded with highly processed foods and food alternatives, there are consumers who wish to live healthy lifestyles and to manage their weights by consuming wholefoods. However, it is often challenging for a consumer to buy wholefood ingredients and then to prepare a balanced meal, while tracking the ratios of the essential nutrients present in the ingredients used to prepare the meal. Ideally, a balanced meal should include ingredients selected from foods which are healthy sources of fiber and the three essential nutrients, viz. proteins, carbohydrates and fats. It has been shown that the nutrients should be present in specific ratios to stabilize and optimize insulin levels, and food ingredients should be selected keeping these ratios in mind.

The sources of the nutrients may influence the effect of a meal on a consumer's metabolism. A specific example is the source of carbohydrates. Both starch and vegetables are carbohydrate-rich; however the metabolic effects of vegetables and starch are not the same.

By relying only on information which is provided on labels, it is daunting and time consuming for a consumer to count and accumulate a daily caloric target, made up of foods selected from ingredients which, in combination, have the correct nutrient ratio. Attempting a similar exercise with fresh foods that have no packaging or labelling is extremely difficult.

To make life simpler, many consumers buy ready-made meals, marketed as “balanced”, such as frozen dinners. Similar to the convenience foods, these ready-made meals are often manufactured using highly processed ingredients, additives, dyes and artificially manufactured or processed proteins, which cannot replace fresh wholefood.

Another problem faced by consumers wishing to live healthy lifestyles is confusing labelling. The USDA allows an error of flexibility on food labelling of up to 20% (eg. calories could be up to 20% higher or lower than actually claimed on a label). Food manufacturers often refer to a recommended daily allowance (RDA) in a misleading manner, indicating, for example, that a frozen dinner's carbohydrate content is low and the protein content is high, relative to the RDA, leaving the consumer under the impression that the meal is healthy, when, in fact, it may have a high fat, preservative, sodium or additive content. The misconception is normally caused by referring to nutrient content on a label in terms of percentages. A relatively low amount of protein could be reflected in a high percentage value, due to the low RDA of protein. Similarly, a high amount of carbohydrates could have a low percentage value. This misconception could lead a consumer to interpret the label incorrectly, inferring that the meal contains “less bad and more good”.

Another misleading concept regarding healthy lifestyles is the six meals a day philosophy. Many trainers, dieticians and diet companies recommend that dieters should eat every 2 to 3 hours to maintain sugar levels. This normally equates to 6 to 8 mini-meals per day. This philosophy is based on the following reasoning:
1. It satisfies an urge to eat excessively by providing smaller, more regular, mini-meals; and
2. It manages blood sugar levels throughout the day, decreasing spikes in insulin levels

Problems with the philosophy are the following;
1. As glucose in the bloodstream is constantly replenished by the consumed meals, the body does not release stored fat as glucose. Insulin is also constantly present in the bloodstream, due to the body's insulin response to glucose levels;
2. Following a traditional calorie restrictive diet of 1200 calories results in an average mini-meal of only 150 to 200 calories (8 to 6 meals). Creating a mini-meal that has all 3 essential nutrients plus fiber, in the right proportions, is extremely difficult and time consuming and inevitably results in a consumer dropping key nutrients, for example by only eating a fruit or easy-on-the-go snacks like protein and fiber bars, which are all high in sugars and other processed ingredients. This causes a consumer to loose muscle mass and does not create a sustainable weight management system.

### The USDA-FDA Established Recommended Daily Allowance

The RDA nutritional content, as established by the USDA-FDA for a 2000 calorie diet, is reflected in Table 1.

| Food Group | Weight in grams | Percentage content |
|---|---|---|
| Total Carbohydrates | 300 | 68% |
| Protein | 50 | 11% |
| Fiber | 25 | 6% |
| Fat | 65 | 15% |
| TOTAL | 440 g | 100% |

From Table 1 it can be seen that if a consumer were to adopt an RDA approach, he would be consuming significantly more carbohydrates and fats than fiber and protein to achieve the nutritional recommendation. This disproportionate ratio is not conducive to good health nor to insulin management.

Criticisms against the RDA approach are that it fails to account for individual differences, and it fails to address disease prevention and optimal nourishment. As such, an RDA basis may be considered as only being suitable for an individual who is healthy and is at an optimum weight.

Another shortcoming of an RDA guideline is that it does not place emphasis on consuming balanced meals which include ingredients which contain fiber and the three nutrients. Nor does the RDA approach emphasise that the nutrients should come from healthy sources. Meals that are not balanced and that do not contain nutrients from a variety of sources do not manage insulin levels effectively, and cause insulin spikes. For example, obtaining carbohydrates from only one source, such as starch, is not healthy—it is important for consumers to realise that a large portion of their daily carbohydrate allowance should be obtained from vegetable sources.

This specification is to be read in conjunction with the disclosure in the applicant's international application No. PCT/IB2014/000137 (“the earlier specification”) the content of which is hereby wholly incorporated into this specification.

The present invention is concerned with providing a food product to simplify the effective implementation and conduct of a weight management program which could include weight loss, weight gain, or weight management, goals, according to a consumer's requirements.

### SUMMARY OF THE INVENTION

The invention provides a bulk food product for use in a weight management program, which product is manufactured at a location remote from a consumer, with sufficient content for at least one portion of a defined size which constitutes a meal, the content being made up of ingredients which are healthy sources of fiber, and of essential nutrients including protein, carbohydrate and fat, wherein the fiber and nutrients are present in the following proportion to stabilise insulin levels, on a per unit mass basis;
1. protein is present in 26 to 40 mass units
2. fat is present in 7 to 16 mass units;
3. carbohydrate from a starch source, is present in 15 to 20 mass units;
4. carbohydrate from a vegetable source is present in 20 to 30 mass units; and
5. fiber is present in 11 to 21 mass units.

“Weight management”, in terms of this specification, refers to weight loss, weight gain or weight maintenance, according to the circumstances.

The bulk food product preferably comprises a plurality of complete balanced meal portions, each portion having the correct ratio of essential nutrients and fiber

The food product may be used to implement any type of balanced diet and can be used for weight loss, weight maintenance or weight gain purposes, or as a snack or meal substitute.

The food product may be safely used to implement a calorie restricted diet for weight loss, by reducing the amount of the food product which is consumed per meal.

The food product may be used, for example by adolescents or athletes, to gain weight healthily by increasing the size of the portion of the food product, i.e. the amount, consumed per meal. Additional portions may also be consumed as snacks between meals.

A side dish, such as an egg or a salad, may be added as required by the consumer. For example, an athlete/bodybuilder may wish to add an extra protein source in the form of an egg etc.

While a meal portion of the bulk food product is flexible, a baseline serving has been established as between 400g to 525g of the bulk food product. This is approximately equal to 400 to 525 calories. Preferably, the baseline serving is about 450g of the food product which provides approximately 450 calories.

Each baseline serving includes ingredients, which provide the fiber and the essential nutrients, in the following quantities:
1. 26 to 40g of protein;
2. 7 to 16 g of fat;
3. 15 to 20g of carbohydrate from a starch source;
4. 20 to 30g of carbohydrate from a vegetable source or non-starch sources such as beans and legumes;
5. 11 to 21g of fiber, from any source;
6. 1 to 10g of a proprietary food blend;
7. 1 to 3g of a proprietary natural preservative blend.

The protein may be obtained from food sources known to be high in protein. Specifically, the protein source may be selected from lean meat, such as chicken without skin, beef, pork and fish. Alternatively, the protein source may be selected from a variety of beans to create a vegetarian-friendly bulk food product.

The carbohydrate from the vegetable source may be obtained from any vegetable source including, but not limited to, carrot, spinach and other vegetables.

The carbohydrate from the starch source may be obtained from any starch source including, but not limited to, potatoes, rice and yams (sweet potato).

The proprietary food blend includes a selection of natural plant based foods, such as wheat grass, flax, wheat germ and other ingredients high in nutrition and fiber. The blend may also include enzymes and probiotics that are conducive to health.

The natural preservative blend may include natural ingredients which preserve food and provide flavour such as sea salt, lemon, rosemary oil, garlic and other natural flavourings.

The ingredients may be selected to create a variety of different bulk food products suitable to different tastes e.g. suitable ingredients can be selected to produce a sweet food product, a savoury food product, a vegetarian food product, etc.

The size of a serving is preferably adequate to provide sufficient energy to support the caloric requirements of a consumer for about 3 to 5 hours depending on the consumer's energy expenditure or objective.

A serving of the food product may be diluted to create a stew or a soup. The food product may also be customised for an individual consumer's taste by adding spices and natural flavourings.

The bulk food product may be sold via an online system, using appropriate software, and may be delivered to a consumer's specified address.

The bulk food product, or portions thereof, may also be delivered to retail outlets or restaurants.

Although the food product may be provided as a single portion it is preferably delivered in bulk form, frozen or refrigerated.

The various food ingredients of the bulk food product are prepared separately under controlled conditions, at a food preparation facility remote from a consumer, and are combined, mixed or blended to form the bulk food product which is then packaged into one or more appropriate containers for shipment or transport.

In one example, the bulk food product is used to implement a weight management program in terms of which a consumer establishes his/her daily base food allowance or requirements, in a defined unit system which contains an index of food values and selects food for consumption based at least on food index values in the system.

The number of units of the food consumed each day by the consumer should be within 90 to 110% of the consumer's daily base food allowance expressed in the units.

The food value index includes defined portions of foods, categorised in terms of their respective content of essential nutrients. A food value, in the units, is assigned to each food portion. The food value is determined using certain parameters including calories, protein content, carbohydrate content, fiber content, fat content and processed content.

The daily base food allowance may be established using parameters that pertain to each individual consumer including gender, age, height, weight, waist circumference and life activity. Each parameter has a set of categories associated with a predetermined value. For example a gender category includes male and female classes; an age category may be divided into ranges for example from 20 to 30 years, from 30 to 40 years, etc.; a life activity category may, for example, allow for a sedentary, inactive, moderately active, active or very active, lifestyle. Parameters relating to height and weight are used in combination to determine a body mass index (BMI), a concept known in the art. A BMI range is also divided into classes, e.g. from 18 to 24, from 24 to 30, etc.

To establish the daily base food allowance, a consumer accumulates the values from each category that are relevant to his/her measurements - the total constitutes the daily base food allowance.

An exercise index may be established wherein values (in the aforementioned units) are assigned to particular exercises of defined durations. A consumer may increase his daily base food allowance by adding the unit values of the exercises to his initial daily base food allowance. This, in turn, will allow the consumer to consume a correspondingly greater quantity of the food product.

The bulk food product comprises a plurality of complete balanced meal portions. Each portion is associated with a food value (in the units) that is calculated based on the relevant food values linked to the ingredients contained in the product, making it easy for the consumer to keep track of the number of units that have been consumed and to correlate this consumption with his daily base food allowance, typically of the order of 450 units to 500 units depending on activity. When consuming a meal/serving of the food product, the consumer is assured that the meal is balanced and contains ingredients selected from all varieties of foods, categorised in terms of their fiber and essential nutrient content, ensuring that the essential nutrients are present in a ratio which is optimal for stabilising insulin resistance.

An additional portion of a complete meal or additional ingredients or a side dish e.g. an egg or a salad, may be added to make up a shortfall between the food index points of a complete meal and the daily base food allowance of the consumer.

The consumer can choose when to eat all or a part of his/her daily base food allowance. The responsibility or discretion placed on a consumer to select ingredients is removed. Psychologically, this has a substantial benefit in that the consumer is relieved of the flexibility of choice and, when eating a complete meal product is inherently assured of consuming the appropriate number of food units, containing fiber and the three essential nutrients in the correct combinations and proportions.

### DESCRIPTION OF PREFERRED EMBODIMENT

The following description refers to Tables 2 to 6, attached hereto.

The invention provides a bulk food product for use in a weight management program, made up from a mixture of primary ingredients selected from whole foods containing fiber and the three essential nutrients, i.e. proteins, carbohydrates and vegetables; a proprietary food mixture; and a blend of natural preservatives, combined in predetermined proportions shown to stabilize and optimize insulin levels.

The food product is used to implement a diet plan for maintaining body weight, losing weight or gaining weight in a healthy and nutritious way.

The ingredients are cooked separately, to optimize flavour and nutritional value, and the cooked ingredients are then combined or mixed to form the bulk food product.

The mixture includes sufficient content for multiple balanced meals or meal portions, where each meal has the same composition of fiber and essential nutrients. Typically a bulk food product, provided to a consumer, would include sufficient content for 1 to 24 meals.

460g of the mixture comprises a single portion or meal which provides approximately 460 calories. If necessary (depending on a consumer's goal e.g. weight loss, weight gain or weight management) additional ingredients or a side dish, such as an egg or a salad, can be included with a meal.

Optionally, the food product can be consumed in smaller portions, as snacks, by reducing the amount consumed at a time to, say, a third of a portion/half a cup. A quantity of the food product can also be diluted to create a stew or soup, to produce a nutritious, cost-effective meal.

An example of amounts of ingredients included per meal, is as follows;
1. 26 g to 40 g of protein
2. 7 g to 16 g of fat;
3. 15 g to 20 g of carbohydrate from a starch source;
4. 20 g to 30 g of carbohydrate from a vegetable source or other non-starch sources;
5. 11 g to 21 g of fiber;
6. 1 to 10 g of a food blend;
7. 1 to 3 g of a proprietary natural preservative blend.

The vegetable group comprises multiple vegetables including, but not limited to, carrots, spinach and other green vegetables; the starch group includes rice, potato and yam (sweet potato), or a combination thereof; and the protein group includes chicken, beef, lamb, pork, fish and beans (vegetarian) or a combination thereof. These foods are by way of example only and are non-limiting. The ingredients can be selected to create a variety of different food products, having the same nutritional composition, e.g. a sweet food product can be created by combining ingredients which include coconut, beans, quinoa, hemp, raw cocoa, squash or other sweet vegetables.

Table 2 provides further information on the composition of the food product. The portion size of a single serving of food product, according to Table 2 is equal to 450 grams which is approximately 16 ounces or 2 cups of food which would be regarded as a good size meal to satisfy most people. The caloric value of 450 calories is sufficient to sustain a person between meals, depending on activity.

Table 2 shows that each ingredient, selected as being representative of one of the essential nutrients, includes trace amounts of the other essential nutrients. For example chicken, which has a high protein content and is therefore selected to represent this nutrient in the meal portion, has some fat content. Similarly a vegetable, such as spinach, includes some protein, fat and fiber in addition to its carbohydrate content. The essential nutrient content for each selected ingredient is taken into consideration when preparing the food product to ensure that the defined proportions are closely adhered to.

Carbohydrates, consumed alone, cause insulin spikes which lead to cravings and hunger pangs. For this reason, it is important to consume carbohydrates in combination with protein and fiber, to control the insulin spikes.

The nutritional compositions of most foods are known or determinable and a comprehensive chart showing nutritional breakdown of all foods is therefore not included in this specification.

Table 3 shows the recommended percentage content for protein, carbohydrate, fiber and fat respectively, based on 2000 calories of the food product of the invention.

From Tables 2 and 3 it can be seen that a consumer eating 2000 calories of the food product will consume fiber and essential nutrients in quantities that vary from the RDA. Specifically Tables 2 and 3, when compared to Table 1, highlight the dominance, recommended by the USDA, of carbohydrates and fat (83%) with fiber and protein representing only 17%. The food product of the invention requires that the fiber and protein contents should be more than the USDA recommendations, and that the fat and carbohydrate contents should be less than the USDA recommendations. It is believed that these ratios are more conducive to managing insulin levels in a healthy manner.

A chosen quantity of the mixture, prepared in accordance with the aforementioned requirements, sufficient, say, for 8 to 24 meals, is packed into a container. A scoop or cup, of a defined size, can be provided so that a consumer can make an accurate measurement of a food portion or a meal—by way of example a standard measuring cup would contain one half of the recommended size of a meal portion of the food product.

After packaging, the container and its contents are snap frozen or refrigerated.

The bulk food product can be distributed (sold) in any convenient manner. The product lends itself to sales via online orders, using appropriate software which is linked to the software referred to in the earlier specification, and can be delivered to a consumer's residence, work place or other specified address. The food product could also be delivered to retail outlets in bulk for resale by retailers or the recipe and certain portions of the food product could be provided to retailers or restaurants etc. for preparation and sale under license.

The food product that is frozen or refrigerated can be packaged and shipped with sufficient ice packs to allow for the food product to arrive in 1 to 3 days frozen or refrigerated

Meals, in one or more portions for one or more people, can be consumed cold or can be microwaved or conventionally heated prior to consumption.

The invention thus extends to a bulk food product which is prepared from a mixture of primary ingredients which are selected using the food index system referred to in the earlier specification, in sufficient quantities to make up at least one meal, but preferably a plurality of meals. The mixture includes portions, or parts of portions, of fiber and essential nutrients (i.e. protein, carbohydrate and fat) and additional proprietary ingredients.

One significant benefit lies in the fact that the bulk food product offers a commercially effective and convenient manner of adapting and implementing a weight management regime in terms of which a consumer establishes his/her daily base food allowance, in a defined unit system, and selects food, which is to consumed, from an established food value index, listing food values specified in the same unit system. It is recommended that a person should consume from 90% to 110% of his daily base food allowance for a healthy and effective weight management plan.

In the food value index system shown in Table 4 food varieties are divided into four categories comprising vegetables, protein, carbohydrate and fat. Each category is divided into sub-categories as follows: vegetables are divided into green vegetables and other vegetables (red, white, orange); protein sources are divided into egg, fish/shellfish, white meat, red meat, dairy and raw nuts; carbohydrate sources are divided into berries, other fruit, starch and grains; fat sources are divided into oils, salad dressing and butter. Each sub-category is assigned a value which is referred to as the “food value”, represented in units.

Table 4 reflects portion sizes (third column) that are allocated to each sub-category of food, and food values (fourth column) associated with each portion. The food values of Table 4 can be used in the method of the invention according to the following example: a portion (1 cup) of green vegetables has a food value of 10 units; two portion (6 ounces) of white meat has a food value of 80 units; one portion of fat (1 teaspoon) has a food value of 20 units; and one portion (1/2 cup) of starch has a food value of 40 units. Each food value for the corresponding portion is based on the following: calorie content (energy value), sugar content (glucose and insulin effect), fiber content, protein content, fat content and processed content (additives, refined sugars, and health benefit, whether positive or negative).

A general formula for determining the food value (FV) for each type of food is as follows.

For a given amount of the food, i.e. a food portion expressed in a conventional measurement unit (a cup, an ounce, a tablespoon, millilitres, grams or the like), the following assessments are made:
1. a base energy value (B) is determined by dividing the calorie value of the food portion by 3;
2. the following values, for the chosen food portion, are established in grams;

2.1 fiber content

2.2 protein content (P);

2.3 sugar content (S);

2.4 fat content (FT); and

2.5 processed content (PC).

The food value for the chosen food portion is established by subtracting the positive values items (fiber and protein) from the base energy value (B) and by adding the negative value items (sugar, fat and processed content) to the base energy value (B), as follows:.

FV=B−F−P+S+FT−PC

The values may be rounded for simplicity.

The formula has been established and proven, by trial and experimentation, as an effective basis for implementing the method of the invention.

Clearly it is possible to scale the food value (FV) up or down, to a convenient-to-use figure, by correspondingly increasing or decreasing the size of a portion.

When using the formula, the food value, FV (in units), per food type is generally equated to between 2.7 and 3 calories per unit. As an example: the food value of the meal described above, of 150 units, equates to about 450 calories at a ratio of 3 calories per food value unit. If used for 3 meals, as a daily example, this equates to 450 units and approximately 1,350 calories.

Table 5 contains a listing which allows a consumer to perform a metabolic calculation to determine his or her daily base food allowance in terms of units which correspond to the units used to represent the food values in Table 4.

The base food allowance is linked to the following parameters, namely: the consumer's gender, age, body mass index (BMI) and life activity, as set out in a first column of Table 5 Other parameters, such as the consumer's height, weight and waist circumference can be used as an alternative to the consumer's BMI. A second column of Table 5 contains, in respect of each of the aforementioned parameters, the number of units in the corresponding base food allowance.

A third column in Table 5 (headed BFA calculation) allows a consumer to enter the number of units which apply to him/her. For example, a male consumer in the age group of 51 to 60, with a BMI score of 36+, and with a medium life activity index, has a base food allowance of 470 units.

The values in Table 5 are used to establish whether a consumer should optimally consume more or fewer food value units per meal, or per day. A formula is used to generate a personalized base food allowance value (BFA) which is regarded as the ideal food consumption for a consumer using the food value index before any exercise activity.

It is generally established that males have higher base metabolic rates than females and, as such, gender is a dominant variable in determining the BFA. The value assigned to a consumer based on gender is known as the base allowance.

A consumer's metabolism slows down with age. In Table 5, the scale typically has a 5 point drop by decade. Exceptions are for the decades 31 to 40, and 41 to 50. In these age brackets there is a 10 point drop to accommodate the known drop in metabolism from age 35.

The higher a consumer's body mass index (BMI) the less his metabolism performs and (generally) the more weight the consumer needs to lose. BMI is calculated by dividing the consumer's weight in kgs, by his height in meters squared. By way of example, a person who is 1.8 m tall and who weighs 80 kg has a BMI of about 24.7 =(80/[1.8]²). The BMI calculation could be replaced with other body mass composition estimates such as waist circumference.

Life activity relates to a consumer's energy requirements based on lifestyle and work activity before exercise activity. As an example, a 65 year old male with a BMI of 36 and with a sedentary lifestyle has a BFA (base food allowance) of 455. A 20 year old male with a BMI under 20 and with high life activity has a BFA of 530

To avoid exercise-induced muscle loss or muscle loss due to an insufficient energy intake, an exercise activity index is employed to increase the food allowance of a consumer, based on exercise activity. The increased food allowance also serves to motivate the consumer to be active—see Table 6.

Table 6 shows the activity index, in units which correspond to the units which apply to Table 4 and Table 5. The activity index is determined in accordance with exercise type i.e. strength training, high intensity interval training/endurance training and cardio (constant-medium intensity), and the duration of the exercise. Each exercise type is further subdivided into more specific categories of exercise.

Exercise value points are based on the duration of performing a particular exercise. The duration is measured in 5 minute time intervals with each subsequent 5 minute interval having a higher value than the previous 5 minute interval. The incremental increase in exercise value encourages exercise for longer intervals.

If a consumer performs a particular exercise for a defined time interval, the value determined by the activity index can be added to the BFA, increasing the daily food allowance of the consumer.

Thus, with reference to Table 6, if a consumer does strength training for 20 minutes together with 15 minutes of steady walking, the activity index for that consumer per day is 85 units.

The use of the bulk food product can be controlled directly, e.g. by a consumer who follows a chart, tables or the like.

The weight management method can, however, be implemented using software which enables a consumer to create a profile which includes all relevant personal information, and his particular weight management goal (i.e. weight loss, weight gain or weight maintenance). The software uses this information to calculate the consumer's daily base food allowance and to log daily food consumption and activities.

In a preferred implementation of the method use is made of a computer link, e.g. the internet, which allows the consumer to interact individually with a program located at a suitable server.

The consumer, once authorised, is guided to register an online profile. The consumer is prompted to enter information in accordance with predetermined parameters and in response thereto a calculation is done to determine the consumer's base food allowance.

The consumer is subsequently prompted to enter information on the consumer's activities on a daily or other regular basis. Each activity which is logged is influenced by the activity index.

Alternatively or additionally the program, in response to data input by the consumer, generates an activity program suited for the consumer which, inherently, will lead to the allocation of units, associated with the activity index, to the consumer's daily food allowance.

In response to the determined base food allowance and logged activities the program then outputs the daily food allowance for the consumer which is the sum of the daily base food allowance (in units) and allocated units due to activities performed, where the units are provided by the activity index. This information is used to determine at least the size of each portion of the bulk food product which is thereafter supplied to the consumer.

In any weight management program motivation is a key ingredient to success. Motivational factors are introduced by the program and presented to the consumer in various forms, e.g. a message which brings home to the consumer the importance of managing food intake using the bulk food product of the invention.

Additionally, a results-tracking program is started and updated regularly. This allows the consumer to have a personal assessment, commencing at a starting point, which includes data such as the consumer's starting weight, starting waist measurement, base food allowance and activity index. The daily food allowance may be updated as consumed food and/or activities are logged and notification of the updated daily food allowance is given to the consumer by the program.

Other information of interest, primarily related to motivational aspects, may be included and displayed at appropriate intervals to the consumer. For example data on the consumer's goal weight, metabolic age estimate, stress and emotional eating score, and processed food score may be included.

A primary reason behind the use of the personal assessment program lies in the fact that it provides a ready means for implementation of the weight management method of the invention. This, however, is done in a way which motivates the consumer to achieve targets and to become aware of the effect that the intakes of different types of food could have on the consumer's body. Ultimately the use of the personal assessment program helps the weight management method to be implemented in a reasonable and not in a stressful manner and leads the consumer to a healthy eating style which can readily be maintained.

A primary objective of the food product is to enable the consumer to eat balanced meals of healthy foods without suffering from hunger pangs, food cravings, and isolation from family and friends, particularly at meal times. In the last-mentioned respect it is recognised that social considerations can weigh heavily on the effectiveness of a weight management regime and, taken in isolation, a weight management program which a consumer regards as antisocial could cause the consumer to abandon the program in its entirety.

Essentially the invention enables the consumer to balance energy in against energy expended with a difference which is linked to weight loss, weight gain, or weight maintenance, as the case may be. This allows the consumer to achieve weight management on a consistent and sustainable basis. The food groupings and portion control allow the consumer to maintain a high energy level. Risks which are associated with diabetes and heart disease and which are linked to the intake of certain food types are reduced in the management method of the invention.

The provision of the bulk food product substantially simplifies the weight management process, be it for weight gain, weight loss or weight maintenance purposes. The bulk food product, prepared under tightly controlled conditions provides one or more meals, in bulk form, with each meal having a fully balanced composition derived from fibre and essential nutrients i.e. protein, carbohydrate and fat.

For inherently different flavors the bulk food product can be provided with a chicken base, a beef base, a vegetarian base, or the like. Supplements consisting for example of stir fried vegetables can be added to a meal portion.

The utility and efficacy of the composition of the bulk food product have been demonstrated in a trial in which 33 subjects participated in a weight loss program. The effects of the program on each subject were tracked for a period of 29 weeks. Subjects were required to create meals based on the food product and to consume the food product in quantities corresponding to their daily food allowances as described above. Subjects also were required to participate in an exercise regimen.

On average the 33 subjects were 74% compliant in respect of food intake and 75% compliant in respect of exercise, i.e. activity index. In particular the subjects consumed, in food terms, approximately 600 units per day (this is about 1700 calories per day) before exercise and before taking into account the “bonus” units associated with each person's activity index. Each person on average exercised for 90 minutes per week.

Despite a calorie intake which was meaningfully larger than the intake allowed by a calorie-restrictive diet, the subjects reported an average weight loss of 32 lbs over the 29 week test period, i.e. a weight loss of slightly more than 1 lb per week. The lowest weight loss over the 29 week period of a subject was 11 lbs and the highest weigh loss of a subject was 49 lbs.

There was a significant reduction (6 inches) in average waist measurement and the average reduction in body mass index was 15%.

The subjects ate wholefoods, real fats and sugar and minimised the intake of low fat and sugar substitutes. The subjects stabilised their insulin levels, reducing their triglyceride indexes by 28% and blood glucose levels by 9% with all risk factor indicators lowering significantly.

20 of the 33 participants had metabolic syndrome, i.e. they were at risk of diabetes and heart disease, at the start of the trial. At the end of the 29 week period only 2 of these participants had metabolic syndrome and, as a group, risk factors in total were reduced by 64%.

75% of the subjects who were on cholesterol-lowering medications were able to eliminate such medications. 67% eliminated their diabetes medications and 50% eliminated blood pressure medications.

The bulk food product of the invention frees a consumer from selecting ingredients and making up balanced meals. Minimal effort and work are required by a consumer, using the bulk food product of the invention, to implement a weight loss, weight gain or weight maintenance program, in a cost effective, safe and healthy manner without harmful side effects.

The balanced nature, high protein and fiber levels and recommended portion sizes help to manage insulin levels/insulin resistance, and sustain a consumer for from 3 to 5 hours. The food product can also be used effectively in shelters or could be shipped to third world countries to treat malnutrition in a cost effective manner.

TABLE 2
Food Product Nutritional Panel

| | | | | | | Nutritional Value | | | |
|---|---|---|---|---|---|---|---|---|---|
| | | | | Food | Protein | Fat | Carb | Fiber | |
| | Ounces | Grams | Calories | Value | Grams | Grams | Grams | Grams | Total |
| Food Product | | | | | | | | | |
| Lean Chicken (white) | 2.75 | 77.96 | 128.3 | 40 | 24.18 | 2.79 | 0.00 | 0.00 | |
| Bean | 2.00 | 56.70 | 72.5 | 32 | 4.26 | 0.06 | 14.04 | 4.14 | |
| TOTAL PROTEIN | 4.75 | 134.66 | 200.8 | 72 | 28.44 | 2.85 | 14.04 | 4.14 | |
| Carrots | 2.00 | 56.70 | 20.0 | 5 | 0.00 | 0.00 | 4.00 | 2.00 | |
| Spinoch | 3.00 | 85.05 | 20.0 | 4 | 2.53 | 0.22 | 3.19 | 2.03 | |
| Squash | 1.50 | 42.53 | 12.0 | 4 | 0.28 | 0.11 | 2.75 | 0.60 | |
| Sub Total Carbohydrates (vegetables) | 6.50 | 184.28 | 52.0 | 13 | 2.81 | 0.33 | 9.94 | 4.63 | |
| Carbohydrates (starch such as potato) | 4.00 | 113.40 | 64.0 | 40 | 1.16 | 0.12 | 15.00 | 2.13 | |
| TOTAL CARBOHYDRATES | 10.50 | 297.68 | 116.0 | 53 | 3.97 | 0.45 | 24.94 | 6.76 | |
| FAT (oil) | 0.40 | 11.34 | 95.0 | 15 | 0.00 | 10.80 | 0.00 | 0.00 | |
| PHYTO BLEND | 0.29 | 8.22 | 30.0 | 8 | 3.20 | 1.00 | 4.35 | 3.35 | |
| PRESERVATIVE-FLAVOR BLEND | 0.04 | 1.05 | 8.0 | 2 | 0.30 | 0.10 | 1.40 | 0.35 | |
| One Serving of the Food Product | | | | | | | | | |
| 1 Serving of Food Product | 16.0 | 452.9 | 450 | 150 | 35.91 | 15.20 | 44.73 | 14.60 | 110.44 |
| | | | | | 32.5% | 13.8% | 40.5% | 13.2% | 100.0% |
| Nutritional Grams Per Calorie | | | | | 0.0798 | 0.0338 | 0.0995 | 0.0325 | |
| Food Product | | | | | | | | | |
| Daily RDA Nutritional Percentage | | | | | 71.8% | 23.4% | 14.9% | 58.4% | |
| Food Product Based On 2000 Calorie Diet | | | | | | | | | |
| Food Product Values for 2000 Calories | | | 2 000 | | 159.7 | 67.6 | 198.9 | 64.9 | 491.10 |
| Content Percentage | | | | | 32.52% | 13.76% | 40.50% | 13.22% | 100.0% |
| Vs. Recommended RDA | | | 2 000 | | 50.00 | 65.00 | 300.00 | 25.00 | 440.00 |
| | | | | | 11.36% | 14.77% | 68.18% | 5.68% | 100.0% |
| Difference Food Product vs. RDA | | | 2 000 | | 109.7 | 2.6 | −101.1 | 39.9 | 51.10 |
| | | | | | 68.7% | 3.8% | −50.8% | 61.5% | 10.4% |
| Phyto Blend | | | | | | | | | |
| Flax | 0.05 | | 5.00 | | 0.20 | 0.50 | 0.35 | 0.35 | |
| Wheat Grass | 0.14 | | 15.00 | | 1.00 | 0.00 | 2.00 | 2.00 | |
| Other Phyto Foods | 0.05 | | 5.00 | | 1.00 | 0.50 | 2.00 | 1.00 | |
| Enzymes and Probiotics | 0.05 | | 5.00 | | 1.00 | 0.00 | 0.00 | 0.00 | |
| Phyto Total | 0.29 | | 30.00 | | 3.20 | 1.00 | 4.35 | 3.35 | |
| Preservative-Flavor Blend | | | | | | | | | |
| Sea Salt: sodium | 0.01 | | 0.00 | | 0.00 | 0.00 | 0.00 | 0.00 | |
| Lemon | 0.01 | | 0.35 | | 0.00 | 0.00 | 0.10 | 0.00 | |
| Rosemary | 0.01 | | 1.85 | | 0.05 | 0.10 | 0.30 | 0.20 | |
| Garlic | 0.01 | | 4.65 | | 0.25 | 0.00 | 1.00 | 0.15 | |
| Apple Cider Vinegar | 0.01 | | 0.00 | | 0.00 | 0.00 | 0.00 | 0.00 | |
| Preservative-Flavor Total | 0.05 | | 6.85 | | 0.30 | 0.10 | 1.40 | 0.35 | |

TABLE 3

| Food Group | Weight in grams | Percentage content |
|---|---|---|
| Carbohydrates | 199 | 40% |
| Protein | 160 | 33% |
| Fiber | 65 | 13% |
| Fat | 68 | 14% |
| Total | 492 | 100% |

TABLE 4

| | Examples or Recommendations | Portion | | Food Values |
|---|---|---|---|---|
| Vegetables | | | | |
| Green (Cooked or raw) | Broccoli, spinach, green beans | 1 | cup | 10 |
| Other (Red, white, orange) | Cauliflower, Carrots | 1 | cup | 20 |
| Protein | | | | |
| Egg | | 1 | | 25 |
| Fish/Shellfish | Salmon, scallops | 3 | oz | 35 |
| White meat | Chicken, turkey, pork | 3 | oz | 40 |
| Red meat | Beef, lamb | 3 | oz | 45 |
| Dairy | Milk, yogurt, cheese | 4 oz or ½ cup | | 45 |
| Raw Nuts | Walnuts, Almonds | 3 oz or ⅓ cup | | 50 |
| Carbohydrates | | | | |
| All Berries | Blueberries, cherries | ½ | cup | 40 |
| All other fruit | Apple, banana | 1 med or ½ cup | | 50 |
| Starch | Potato, sweet potato | 1 med or ½ cup | | 40 |
| Grains | Brown rice, quinoa, multi-grain bread | ½ cup or 1 slice | | 45 |
| Fat | | | | |
| Oils (Olive, Coconut) | | 1 | tbsp. | 10 |
| GOLO salad dressing | | 2 | tbsp | 15 |
| Butter | | 1 | teaspoon | 20 |
| Limit | | | | |
| Natural condiments | Soy sauce, mustard | 1 | tbsp. | 25 |
| Sugars | Honey, syrup, sugar, jam | 1 | teaspoon | 25 |
| Dark chocolate | | 2 | oz | 40 |
| Peanut butter | | 1 | tbsp. | 50 |
| Beer | | 8 | oz | 75 |
| Wine | | 4 | oz | 75 |
| Hard liquor | | 2 | oz | 75 |
| Bacon/Sausage | | 2 oz, 1 link | | 75 |
| Deli meat | | 2 | oz | 75 |
| Avoid | | | | |
| Processed Condiments | Bottled dressings, marinades, ketchup etc. | 1 | tbsp. | 35 |
| Artificial sweeteners | | 1 tsp/1 packet | | 50 |
| Processed Beverages (diet) | Soda, juice, coffee drinks, etc. | 8 | oz | 75 |
| Processed snacks or desserts | Cookies, chips, ice cream, crackers, etc. | 1 | serving | 100 |
| White flour products | Breads, pasta | 1 | serving | 100 |
| Processed Beverages (reg) | Soda, juice, coffee drinks, etc. | 8 | oz | 150 |
| All processed, packaged food | Frozen meals, boxed rice, cereal, etc. | 1 | serving | 150 |
| Protein bars/shakes | | 1 shake/1 bar | | 150 |
| Mixed drinks w/alcohol | | 1 | drink | 150 |

| | | | |
|---|---|---|---|
| All Fast, convenience foods | Burgers, fries, pizza, fried chicken, etc. | meal | 175 |

TABLE 5

| | | BFA |
|---|---|---|
| | | CALCULATION |
| Gender | | |
| Male | 390- | 390 |
| Female | 360 | |
| Age | | |
| <20 | 50 | |
| 21-30 | 45 | |
| 31-40 | 40 | |
| 41-50 | 30 | |
| 51-60 | 25- | 25 |
| 61+ | 20 | |
| Body Mass Composition Estimate | | |
| <20 | 40 | |
| 21-28 | 35 | |
| 29-35 | 25 | |
| 36+ | 20- | 20 |
| Life Activity (not exercise) | | |
| Low (sedentary) | 20 | |
| Medium (some gardening-walking etc.) | 35- | 35 |
| High (physical job) | 50 | |
| Base Food Allowance | | 470 |

TABLE 6

| | 5 | 10 | 15 | 20 | 25 | 30 |
|---|---|---|---|---|---|---|
| | Minutes | Minutes | Minutes | Minutes | Minutes | Minutes |
| Strength Training | | | | | | |
| Spot Training | 13 | 26 | 41 | 55 | 70 | 86 |
| Strength Training (machine-free weights-TRX | 15 | 30 | 46 | 63 | 80 | 97 |
| etc.) | | | | | | |
| Circuit Training (strength training with cardio | 14 | 29 | 44 | 60 | 77 | 94 |
| intervals) | | | | | | |
| High Intensity Interval/Endurance Training | | | | | | |
| Burst High Intensity Training | 12 | 26 | 39 | 54 | 68 | 83 |
| Stair Climbing | 11 | 22 | 34 | 47 | 59 | 72 |
| Endurance (rowing, swimming) | 10 | 22 | 34 | 47 | 59 | 72 |
| High Intensity Workout Classes (Zumba etc.) | 11 | 23 | 35 | 48 | 61 | 75 |
| High Intensity Walking | 11 | 23 | 35 | 48 | 61 | 75 |
| High Intensity Sports (soccer/tennis etc.) | 10 | 20 | 31 | 42 | 54 | 66 |
| Cardio (constant-medium intensity) | | | | | | |
| Cardio Machine | 7 | 15 | 22 | 30 | 39 | 47 |
| Steady Walking | 7 | 15 | 22 | 30 | 39 | 47 |
| Yoga | 7 | 15 | 22 | 30 | 39 | 47 |
| Low Intensity Sports (golf) | 7 | 15 | 22 | 30 | 39 | 47 |

1. A bulk food product for use in a weight management program, which product is manufactured at a location remote from a consumer, with sufficient content for at least one portion of a defined size which constitutes a meal, the content being made up of ingredients which are healthy sources of fiber and essential nutrients, including protein, carbohydrate and fat, wherein the fiber and nutrients are present in the following proportion to stabilise insulin levels, on a per unit mass basis;
1.1. protein is present in 26 to 40 mass units
1.2. fat is present in 7 to 16 mass units;
1.3. carbohydrate, from a starch source, is present in 15 to 20 mass units;
1.4. carbohydrate, from a vegetable source, is present in 20 to 30 mass units; and
1.5. fiber is present in 11 to 21 mass units.

2. A bulk food product according to claim 1 wherein the food ingredients are prepared separately and thereafter are combined, mixed or blended to form the bulk food product which is packaged in one or more containers suitable for shipment.

3. A bulk food product according to claim 1 wherein each meal comprises 400 to 525g of the bulk food product.

4. A bulk food product according to claim 3 wherein each meal provides approximately 400 to 525 calories.

5. A bulk food product according to claim 4 which additionally includes a serving of a proprietary food blend formed from a selection of natural plant based foods including at least wheat grass, flax, wheat germ, enzymes and probiotics.

6. A bulk food product according to claim 4 wherein each meal additionally includes natural ingredients selected from at least sea salt, lemon, rosemary oil and garlic.

7. A bulk food product according to claim 1 wherein the ingredients are selected to produce one of the following: a sweet food product, a savoury food product, and a vegetarian food product.

8. A bulk food product according to claim 1 wherein each meal can be diluted to create a stew or a soup.

9. A weight management method conducted by a consumer for weight loss, weight gain, or weight maintenance, purposes wherein the consumer accesses software and is prompted to enter information, in accordance with predetermined parameters and, in response thereto,
1.1. the consumer's base food allowance is determined,
1.2. an activity index for the consumer is determined, and
1.3. in response to the base food allowance and the activity index a daily food allowance for the consumer is calculated, whereafter the consumer is provided with a bulk food product which is according to claim 1 and which is dependent, in part, on the calculated daily food allowance, and
1.4. the consumer is guided to consume meals derived from the bulk food product and, thereafter, a results-tracking program is implemented to allow the consumer to balance energy in against energy expended to achieve said purpose.
